(19) United States
(12) Patent Application Publication
(10) Pub. No.: US 2008/0075933 A1
(43) Pub. Date: Mar. 27, 2008

(54) Flexible Ballistic-Resistant Assembly

(75) Inventor: Johannes A.P. Rovers, Landgraaf (NL)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., TE Heerlen (NL)

(21) Appl. No.: 11/631,013

(22) PCT Filed: Jul. 1, 2005
(86) PCT No.: PCT/EP05/07225

§ 371 Date: Apr. 9, 2007

Related U.S. Application Data
(60) Provisional application No. 60/610,209, filed on Sep. 16, 2004.

(30) Foreign Application Priority Data
Jul. 2, 2004 (EP) 04076910.1

(51) Int. Cl. B32B 3/00; D05B 23/00

(52) U.S. Cl. 428/196; 112/475.08

(57) ABSTRACT

The invention relates to a ballistic-resistant assembly comprising a stack of a plurality of flexible elements comprising at least one layer containing a network of high-strength fibres, wherein from 5 to 50 mass % of the elements in the rear side part of the assembly contain connecting means that interconnect adjacent elements at multiple spots distributed over their surface. The flexible assembly combines high bullet stopping power with a low trauma effect. The invention further relates to a ballistic-resistant article comprising said assembly and to a method of making said assembly.

The invention relates to a ballistic-resistant assembly comprising a stack of a plurality of flexible elements comprising at least one layer containing a network of high-strength fibres.

The invention further relates to a ballistic-resistant article comprising said assembly and to a method of making said assembly.

Such a ballistic-resistant assembly, also called a ballistic panel or package, is known from U.S. Pat. No. 3,971,072. This patent publication discloses lightweight armour containing an assembly of a thin metal outer shell and a stack of a plurality of flexible layers of a ballistic fabric formed of woven continuous filament yarns, which layers are interconnected across their entire area by connecting or securing means, like stitches, extending along continuous paths, which paths are spaced no greater than three-fourth of an inch (19 mm) and no less than one-eighth of an inch (3.2 mm). By such sewing, or otherwise joining a plurality of layers together, back target distortion of the assembly is stated to be reduced. Such a flexible ballistic-resistant assembly, also called a laminate as protection against ballistic action, is furthermore known from US 2001/0021443 A1. This publication discloses a flexible laminate comprising a plurality of layers composed of a fabric containing high-performance fibres, wherein all layers are connected to one another. The connection between said layers is obtained through adhesive spots, whereby the area of each layer covered by adhesive is around 10 to 95%. The amount of adhesive is between 5 and 35% in relation to the fibre component of the two layers connected to each other.

A ballistic-resistant assembly is generally not used per se, but applied as part of a ballistic-resistant article like a bullet-proof vest or other shaped parts used for protective purposes, including different kinds of soft body armour. Typically, the assembly or panel is inserted into a carrier, which can be constructed of conventional garment fabrics such as nylon or cotton. The ballistic-resistant assembly may be permanently attached to the carrier or may be removable.

Back target distortion, also called back-face deformation, is a term used in the art to refer to the deformation of the back surface of a ballistic-resistant assembly or article against the body of the wearer upon impact of a missile. An impacting missile, like a bullet, may be stopped by the assembly, that is it may not fully penetrate or pierce the material, but it may as a result of its high impacting energy and shock, and resulting local deformation still result in serious injuries to the body or internal organs; commonly referred to as blunt trauma or simply as trauma.

Reduction of blunt trauma is an issue ever since the introduction of modern soft ballistic body armour, like bullet-proof vests, based on high-performance fibres like aramids, e.g. Kevlar® or Twaron®; ultra-high molar mass polyethylene (UHMPE, e.g. Dyneemae® or Spectra®), or poly(p-phenylene 2,6,-benzobisoxazole) (PBO, e.g. Zylon®). Most standards for body armour performance focus on bullet stopping power, but often also quantify maximum allowable trauma. The National Institute of Justice (NIJ) standard 0101.04 rates soft body armour in three main categories: IIA, II, and IIIA (from weakest to strongest protection). Level IIA armour protects against 9 mm full metal jacketed round nose bullets, with nominal masses of 8.0 g impacting at a minimum velocity of 332 m/s, and against 40 S&W calibre full metal jacketed bullets, with nominal masses of 11.7 g impacting at a minimum velocity of 312 m/s. Level II armour protects against 9 mm full metal jacketed round nose bullets, with nominal masses of 8.0 g impacting at a minimum velocity of 358 m/s, and against 357 magnum jacketed soft point bullets, with nominal masses of 10.2 g impacting at a minimum velocity of 427 m/s. Level IIIA armour protects against 9 mm full metal jacketed round nose bullets, with nominal masses of 8.0 g impacting at a minimum velocity of 427 m/s, and against 44 magnum jacketed hollow point bullets, with nominal masses of 15.6 g impacting at a minimum velocity of 427 m/s. Level III and level IV relate to rigid body armours that protect against rifle rounds.

Level IIIA armour is typically used by police officers involved in high-risk operations, such as warrant service, hostage rescue, and protective tasks. In practice, performance of such NIJ certified ballistic vests is often further improved by fitting an additional trauma pad or plate (usually 8×5 inches) on the chest, because the maximum trauma of a level IIIA vest (44 mm) is felt to be too high. Trauma plates can be soft and made of the same material as the protective panels in the ballistic vest, or rigid and made of different materials, including metal sheets; but all have the disadvantage that they increase thickness, add weight, and decrease wearing comfort.

Numerous patent publications address reduction of trauma of ballistic panels for use in soft body armour, which would omit use of additional trauma pads. U.S. Pat. No. 4,413,357 proposes an assembly of a stack of closely woven fabric of aramid fibres, at least one ply of flexible polycarbonate sheeting, and a layer of a soft, relatively thick, foam plastic (from front to rear or back side of the panel). In EP 131447 A, a trauma attenuating layer made from feathers, foam or felt is sandwiched between front and rear layers of ballistic fabric layers, the assembly being consolidated by stitching or other bonding. An assembly comprising several layers of textile and a shock absorber having a three-dimensional structure with a waffle-like structured surface, a voids ratio of at least 90 vol. % and a thickness of 5-30 mm is described in EP 172415A. A ballistic body panel comprising front and rear non-metallic impact resistant layers spaced by a strip defining a closed hermetically sealed air space, for example a closed cell polyurethane foam, is disclosed by U.S. Pat. No. 5,059,467. WO 92/06840 A1 relates to an assembly of a stack of flexible ballistic material and a reinforcing panel engaged with the innermost ply of the stack, wherein the ballistic material can be made of e.g. aramid fibres and the panel can be a polycarbonate extruded sheet. A protective assembly containing a 10 mm thick supple foam layer in combination with fabric layers is described in WO 96/24816 A1. Felt layers are described in CA 2169415 A as means for maintaining an air-gap between stacks of layers of unidirectional aramid fibre-material. A special spacer fabric, comprising a front and back face interconnected and maintained at 12-30 mm from each other by monofilaments, is proposed by U.S. Pat. No. 6,103,641. A multilayer armour construction comprising a front stack of layers of high-strength fibres, e.g. aramid fibres, backed by at least one thermoplastic polyester extruded sheet, and a further stack of such layers backed by at least one thermoplastic polyester sheet is described in U.S. Pat. No. 6,319,862.

A drawback of the assembly known from U.S. Pat. No. 3,971,072 is that the dense stitching reduces flexibility and may also lower ballistic resistance. Other proposed constructions indicated above generally contain additional layers that increase thickness and/or weight of the assembly. There is thus a need in industry for a lightweight ballistic-resistant assembly that combines flexibility with a high level of ballistic protection and low blunt trauma.

According to the present invention, this is provided by an assembly wherein from 5 to 50 mass % of the elements contain connecting means that interconnect adjacent elements at multiple spots distributed over their surface, whereby the interconnected elements are located in the rear side part of the assembly, i.e. the side opposite to the side facing the threat or impacting missile.

The ballistic-resistant assembly according to the invention provides markedly reduced back-face deformation (and thus blunt trauma) without addition of extra layers, e.g. a so-called trauma liner, which would increase thickness and/or weight, while flexibility of the assembly is not or hardly affected.

Another advantage of the assembly according to the invention is that the bullet stopping power, for example expressed in a V₅₀ value, is not deteriorated by the applied connecting means. Still a further advantage is that the assembly according to the invention also provides improved protection against other threats, like other impacting objects like stones, or against e.g. falling. Typical articles that advantageously use the assembly according to the invention include protective parts for elbows, shoulders, wrists, knees, legs, etc.

The ballistic-resistant assembly comprises a stack of a plurality of flexible elements. With a flexible element is meant an element, or a sheet or (laminated) layer, which when held on a flat support with 20 cm of the element protruding from the support bends down under its own weight, with the outer edge of the protruding non-supported part at least 10 mm lower than the supported part of the element. Within the stack of elements, the elements can move or shift relative to each other over at least part of their contacting surface. This movement of elements relative to each other allows the stack of elements to bend and flex, which is obviously preferred for soft body armour applications. In the assembly, the front side is the side facing the threat or impacting missile, whereas the rear or back side is the side opposite to the side facing the threat or impacting missile, i.e. closest to the wearer or the object to be protected. The front side of the assembly—also called strike face-contains elements that are substantially not linked or connected to one another; that is, the elements are not attached or adhered to each other over a substantial part of their adjacent surfaces with connecting means. It is, however, difficult to handle and further process a stack of layers that lacks any coherence. To achieve a certain level of coherence, the assembly can, for example, be stitched through, preferably as little as possible, for example only at the corners or around the peripheral edges (in addition to the connecting means in the rear side elements). Such connection means are not applied to affect ballistic performance or trauma. Another possibility is to enclose the assembly in a flexible cover or envelop.

The ballistic-resistant assembly comprises a stack of a plurality of flexible elements that comprise at least one layer containing a network of high-strength fibres.

Within the context of the present application, a fibre is an elongated body with length dimension much greater than its width and thickness. The term fibre thus includes a monofilament, a multifilament yarn, a ribbon, a strip or tape and the like, and can have regular or irregular cross sections. The term fibre includes a plurality of any one or combination of the above.

High-strength fibres have a tensile strength of at least about 1.0 GPa and a tensile modulus of at least about 40 GPa. The fibres may be inorganic or organic fibres, and suitable fibres are for example listed in U.S. Pat. No. 5,185,195. Suitable inorganic fibres are, for example, glass fibres, carbon fibres and ceramic fibres. Suitable organic fibres with such a high tensile strength are, for example, aromatic polyamide fibres (also simply aramid fibres), especially poly(p-phenylene teraphthalamide), liquid crystalline polymer and ladder-like polymer fibres such as polybenzimidazoles or polybenzoxazoles, esp. poly(1,4-phenylene-2,6 benzobisoxazole) (PBO), or poly(2,6-diimidazo[4,5b4′,5′-e]pyridinylene-1,4-(2,5-dihydroxy)phenylene) (PIPD; also referred to as M5) and fibres of, for example, polyolefins, polyvinyl alcohol, and polyacrylonitrile which are highly oriented, such as obtained, for example, by a gel spinning process. The fibres preferably have a tensile strength of at least about 2 GPa, at least 2.5 or even at least 3 GPa. Highly oriented polyolefin, aramid, PBO and PIPD fibres, or a combination of at least two thereof are preferably used. The advantage of these fibres is that they have very high tensile strength, so that they are in particular very suitable for use in lightweight ballistic-resistant articles.

Suitable polyolefins are in particular homopolymers and copolymers of ethylene and propylene, which may also contain small quantities of one or more other polymers, in particular other alkene-1-polymers.

Good results are obtained if linear polyethylene (PE) is selected as the polyolefin. Linear polyethylene is herein understood to mean polyethylene with less than 1 side chain per 100 C atoms, and preferably with fewer than 1 side chain per 300 C atoms; a side chain or branch generally containing at least 10 C atoms. The linear polyethylene may further contain up to 5 mol % of one or more other alkenes that are copolymerisable therewith, such as propene, butene, pentene, 4-methylpentene, octene.

Preferably, the linear polyethylene is of high molar mass; with an intrinsic visocosity (IV, as determined on solutions in decalin at 135° C.) of at least 4 dl/g; more preferably at least 8 dl/g. Such polyethylene is also referred to as ultra-high molar mass polyethylene (UHMWPE). Intrinsic viscosity is a measure for molar mass (also called molecular weight) that can more easily be determined than actual molar mass parameters like Mₙ and M_{w}. There are several empirical relations between IV and M_{w}, but such relation is highly dependent on molar mass distribution. Based on the equation M_{w}=5.37×10⁴ [IV]¹³⁷ (see EP 0504954 A1) an IV of 4 or 8 dl/g would be equivalent to M_{w} of about 360 or 930 kg/mol, respectively.

High-performance polyethylene (HPPE) fibres consisting of polyethylene filaments that have been prepared by a gel spinning process, such as described, for example, in GB 2042414 A or WO 01/73173 A1, are preferably used. A gel spinning process essentially consists of preparing a solution of a linear polyethylene with a high intrinsic viscosity, spinning the solution into filaments at a temperature above the dissolving temperature, cooling down the filaments to below the gelling temperature, such that gelling occurs, and stretching the filaments before, during and/or after the removal of the solvent.

A layer containing a network of fibres may be formed from fibres alone, from fibres with a suitable polymer coating, or from fibres and a binder, such as a suitable polymer as matrix material. The fibres can be arranged in a network of various configurations. For example, fibres can be made into various different alignments from twisted or untwisted yarn bundles. Suitable examples include a knitted or woven (plain, twill, basket, satin or other weave) fabric, or non-woven structures like a felt or a layer of stabilised unidirectionally oriented fibres. In view of ballistic performance, network configurations wherein the high-strength fibres are mainly oriented in one direction are preferred. Examples hereof not only include layers of unidirectionally oriented fibres stabilised with a binder, but also woven structures wherein the high-strength fibres form a major part of the woven; e.g. as the warp fibres, and wherein the weft fibres form a minor part and need not be high-strength fibres; like the constructions described in EP 1144740 B1 or other wovens referred to as uniweave fabrics.

In case of layers with such unidirectionally oriented high-strength fibres, the element preferably contains at least two layers of unidirectionally oriented fibres with the fibre directions in adjacent layers being rotated to each other; preferably at an angle of between 45° and 90°, more preferably the angle is about 80-90°.

With a layer of unidirectionally oriented fibres stabilised with a binder is meant a layer wherein the filaments are oriented substantially parallel in a plane, which orientation is stabilised with a binder. Such a layer is also referred to as mono-layer in the art. The term binder refers to a material that binds or holds the fibres together and may enclose the fibres in their entirety or in part, such that the structure of the mono-layer is retained during handling and making of elements. The binder material can have been applied in various forms and ways; for example as a film, as transverse bonding strips or transverse fibres (transverse with respect to the unidirectional fibres), or by impregnating and/or embedding the fibres with a matrix material, e.g. with a polymer melt or a solution or dispersion of a polymeric material in a liquid. Preferably, matrix material is homogeneously distributed over the entire surface of the mono-layer, whereas a bonding strip or bonding fibres can be applied locally. Suitable binders are described in a.o. EP 0191306 B1, EP 1170925 A1, EP 0683374 B1 and EP 1144740 B1.

In a preferred embodiment, the binder is a polymeric matrix material, and may be a thermosetting material or a thermoplastic material, or mixtures of the two. The elongation at break of the matrix material is preferably greater than the elongation of the fibres. The binder preferably has an elongation of 3 to 500%. Suitable thermosetting and thermoplastic polymer matrix materials are enumerated in, for example, WO 91/12136 A1 (pages 15-21). From the group of thermosetting polymers, vinyl esters, unsaturated polyesters, epoxides or phenol resins are preferably selected as matrix material. From the group of thermoplastic polymers, polyurethanes, polyvinyls, polyacrylics, polyolefins or thermoplastic elastomeric block copolymers such as polyisopropene-polyethylene-butylene-polystyrene or polystyrene-polyisoprene-polystyrene block copolymers can be selected as matrix material. Preferably the binder consists essentially of a thermoplastic elastomer, which preferably substantially coats the individual filaments of said fibres in a monolayer, and has a tensile modulus (determined in accordance with ASTM D638 at 25° C.) of less than about 40 MPa. Such a binder results in high flexibility of a mono-layer, and of an element and their assemblies. It was found that very good results are obtained if the binder in the mono-layer is a styrene-isoprene-styrene block copolymer.

In a special embodiment of the invention, the binder in the element in the assembly according to the invention also contains, in addition to the polymeric matrix material, a filler in an amount of from 5 to 80% by volume, calculated on the basis of the total volume of the binder. More preferably, the amount of filler is from 10 to 80% by volume and most preferably from 20 to 80% by volume. It was found that as a result, the flexibility of the ballistic resistant article increases without significant adverse effects on the antiballistic characteristics.

The fillers do not contribute to the bonding between the fibres, but rather serve for volumetric dilution of the matrix between the fibres, as a result of which the ballistic resistant article is more flexible and has higher energy absorption. The filler preferably comprises a finely dispersed substance having a low weight or density. The filler may be a gas, although using a gas as filler presents practical problems in processing the matrix material. The filler may also, inter alia, comprise the substances customary for preparing dispersions, such as emulsifiers, stabilizers, binders and the like or a finely dispersed powder.

Preferably, the amount of binder in the mono-layer is at most 30 mass %, more preferably at most 25, 20, or even at most 15 mass %; since the fibres contribute most to ballistic performance.

Preferably, if an element contains two or more layers of fibres, the layers or mono-layers are linked or attached to each other over essentially their whole surface. Such linking or attaching can result from the binder present in the layers, e.g. during laminating or calandering the layers at certain temperature and pressure, but may also result from addition of an additional binding material; like a thermoplastic film between the layers acting as adhesive.

The actual number of layers in an element may vary considerably, depending on the thickness of the layers; but should be chosen such that the element shows flexibility. In general, the thinner a layer, the more layers may be present in the element to retain a desired level of flexibility. In preferred embodiments, the number of layers is from 2 to 8, preferably 2 or 4.

The element may further comprise, in addition to the fibrous layers a film layer on one or both outer faces. Suitable films include thin films, for example of less than 20, 15 or even less than 10 micron thick, made from thermoplastic polymers like polyolefins, e.g. polyethylene, polypropylene or their copolymers; polytetrafluoroethylene; polyesters, polyamides, or polyurethanes, including thermoplastic elastomeric versions of said polymers. The advantage of such films is further stabilisation of the fibrous layers, and increasing flexibility of the assembly by facilitating relative movement of elements. The films may be non-porous, but can also be (micro)porous.

In the assembly according to the invention from 5 to 50 mass % of the elements contain connecting means that interconnect adjacent elements at multiple spots distributed over their surface, whereby the interconnected elements are located in the rear side part of the assembly, i.e. the side opposite to the side facing the threat or impacting missile. The rear side part is understood to be formed by about 75 mass % of the assembly from the rear face. These elements in the rear side part of the assembly can include the last element forming the rear face, but can also be a certain number of interconnected elements that are backed by one or more (not interconnected) elements, or by other flexible layers, which form the rear face of the assembly. Preferably, such other backing elements or layers form at most 25 mass % of the assembly, more preferably at most 20, 15, 10 or even at most 5 mass %.

Suitable connecting means are those that can make a localized connection between two adjacent elements, such that relative movement of the elements over at least part of their contacting surface is still possible. Examples include means like various stitching methods, stapling, riveting, heat welding in different patterns, applying dots of adhesives, applying double-sided adhesive strips, or other means known in the art; so longs as a connection can be made without loosing all relative movement between the elements. For this reason, the connecting means are distributed over the surface. Multiple small spots of connecting means spread over the total surface are preferred over a few local areas having a high density of connecting means.

Preferably, the connecting means cover at most 20% of the surface area of an element, more preferably at most 15, 10, 5, 2, or even at most 1%. The inventors observed that with increasing surface area covered with connecting means, trauma tends to decrease but also flexibility; the relative number of sheets to be interconnected can therefore be lowered accordingly.

The connecting means may be randomly spread over the surface, but may also follow regular patterns or paths. The connecting means can for example virtually follow straight lines, but also curved lines, or circular or spiral paths.

The paths of connecting means, especially stitches, may all run essentially parallel, but may also be at an angle, and thus cross each other; for example as two or more groups of parallel paths crossing each other. Suitable angles are from 10 to 900, preferably from about 45 to 900. The paths of connecting means thus may form typical structures like triangles, squares, stars, or combinations thereof.

Stitching or sewing is the most preferred way of applying connecting means, like lock stitching, conventional chain or zig-zag stitching. Stitches can be applied relatively easy, also through a larger number of elements at once, and the number of stitches per surface area may be readily varied. Stitches also cover relatively little surface area, and thus allow relative movement of elements.

The stitch length, that is the distance between two consecutive points where a stitch thread enters the element in a stitch path, may vary widely. Suitable stitch lengths are from about 1 to about 15 mm, preferably about 2-10 or 3-8 mm.

The distance between adjacent paths of stitches, or other connecting means, may vary widely, for example from about 0.5 to 15 cm. A shorter distance is more effective in reducing trauma, but too short a distance reduces flexibility; whereas too long a distance is hardly effective. Preferably, the distance between stitch paths is at least about 1, 2 or 3 cm, and less than 12, 10, 8 or 6 cm. As indicated above for surface area covered, the shorter the distance of paths, the smaller the number (or mass %) of sheets that are to be interconnected to obtain the desired effect, depending on the type of assembly. The skilled person can find an optimum for a given assembly by some routine experimentation within the indicated limits.

The stitches can be applied by using standard sewing machines, especially industrial sewing machines, and standard sewing yarns or threads can be used. In a preferred embodiment, the sewing yarn is a high-strength yarn, for example similar to the high-strength yarns in the layers of the elements.

In a preferred embodiment of the invention, about 1040 mass % of the elements in the assembly contain connecting means, which elements are located in the rear side part of the assembly, i.e. the side opposite to the side facing the threat or impacting missile; more preferably about 15-35, 17-30, or even 18-25 mass % of the elements contain connecting means. This provides a balance between reduction of blunt trauma and flexibility of the assembly; which improves protection level and wearer comfort of an article comprising such assembly, like a bullet proof vest. For example, in a 40-element assembly the last 10 elements, i.e. about 25 mass %, contain connecting means in the form of crosswise paths of stitches defining squares of 5×5 cm.

In one embodiment of the invention, all elements of the selected number of elements in the rear side part contain connecting means connecting them together as one pack.

In another embodiment, the selected elements in the rear side part are grouped into at least two groups of at least 2 elements, which groups contain connecting means that interconnect the elements within a group. For example, in a 40-element assembly the last 10 elements are grouped in 5 pairs of 2 elements containing connecting means. Especially in such embodiments, the paths of connecting means, e.g. stitches, may be different for the distinct groups of elements, for example differing in the angle the stitch path makes with the element, whereby the different stitch paths of adjacent groups can for example be rotated at an angle; and the paths cross each other virtually (e.g. as if seen through the stack). In this way, the number of connecting means (stitches) per surface area can be reduced. The advantage of such embodiment is a further optimisation of flexibility versus trauma reduction of the assembly. The different groups of elements may also contain a combination of different connecting means; like stitches and adhesive.

U.S. Pat. No. 5,185,195 also discloses a ballistic-resistant assembly comprising a stack of a plurality of flexible fibrous elements, wherein at least two elements have been secured together by connecting means; but the connecting means (stitches) herein extend along adjacent paths having a distance of less than 3.2 mm thus covering a large part of the surface, and are not limited to rear part elements. In the examples all layers of a stack of woven fabrics were sewn together. The very high area density of the connecting means, that are particularly stitches, is indicated to result in improved puncture resistance of the stitched spot; trauma is not discussed.

The application further relates to a ballistic-resistant assembly comprising a stack of a plurality of flexible elements comprising at least one layer containing a network of high-strength fibres, wherein at least 50 mass % of the elements are stitched together in at least 2 groups of at least 2 elements with a distance between adjacent stitch paths of at least about 1 cm. Preferably, at least 75, 85, 90, 95 mass % or even all elements are stitched together in groups. Further preferred embodiments for the elements, mono-layers, fibres, binder, film layer, stitch surface density, stitch length, stitch paths and their orientation are all analogous to the above described embodiments for an assembly wherein only elements in the rear side part are interconnected. The advantage of such assemblies is a combination of low trauma effect and good flexibility; while the bullet stopping power is not reduced. That the stopping power is not reduced even if all elements are stitched is surprising, because the inventors have observed in earlier experiments that stitching in the front layers of an assembly increases the probability of a bullet penetrating the assembly. Without wishing to be bound to any theory, the inventors assume this effect may be related to the number of stitches on the front side elements being relatively low in the present case, thus diminishing the change a bullet hits a stitch.

In a preferred embodiment, the assembly is made up of 24 groups of elements that are interconnected with stitches, wherein the stitch paths in a group run substantially parallel with distance between paths of about 1-10 cm and with stitch length of about 1-15 mm, and wherein the stitch paths of adjacent groups are rotated at an angle of about 10-90°, preferably about 45-90°. The advantage of such assembly is a further balancing of high bullet stopping power, low trauma, and good flexibility.

The invention further relates to ballistic-resistant articles that comprise an assembly according to the invention. Ballistic-resistant articles include body armour, especially soft body armour, like bullet proof vests; but are not limited thereto. The invention specifically relates to those articles where flexibility in combination with a high level of protection, especially low trauma is required. Other typical articles that advantageously use the assembly according to the invention include various protective parts for elbows, shoulders, wrists, knees, legs, etc., which articles offer protection against other threats than bullets, and may be used during working or sporting.

The invention further relates to a method of making a flexible ballistic-resistant assembly with reduced back-face deformation, by stacking a plurality of flexible elements comprising at least one layer containing a network of high-strength fibres, and interconnecting from 5 to 50 mass % of the elements, located in on the rear side of the assembly by applying connecting means at multiple spots distributed over the surface of the elements. The sequence of these steps is not critical, but first applying connecting means to selected elements and then making the stacked assembly is preferred from a practical point of view.

Preferred ways of performing the method of the invention are analogously to the various embodiments discussed above for the assembly of elements.

The invention will be further elucidated with reference to the following experiments.

Methods

IV: the Intrinsic Viscosity is determined according to method PTC179 (Hercules Inc. Rev. Apr. 29, 1982) at 135° C. in decalin, the dissolution time being 16 hours, with DBPC as anti-oxidant in an amount of 2 gA solution, by extrapolating the viscosity as measured at different concentrations to zero concentration;
Tensile properties: tensile strength (or strength), tensile modulus (or modulus) and elongation at break are defined and determined on multifilament yarns as specified in ASTM D885M, using a nominal gauge length of the fibre of 500 mm, a crosshead speed of 50%/min and Instron 2714 clamps, of type Fibre Grip D5618C. On the basis of the measured stress-strain curve the modulus is determined as the gradient between 0.3 and 1% strain. For calculation of the modulus and strength, the tensile forces measured are divided by the titre, as determined by weighing 10 metres of fibre; values in GPa are calculated assuming a density of 0.97 g/cm³ for HPPE fibres;
Ballistic performance of assemblies is determined on 40×40 cm samples with a test procedure according to Stanag 2920 using 0.44 Magnum SJHP bullets (from Remington). An assembly of layers is fixed using flexible straps on a support filled % With Roma plastilin backing material, which was preconditioned about 35° C. Trauma effect is quantified by measuring the indentation depth in the backing material resulting from back face deformation of 4 bullets impacting at 436±10 m/s at 7.5-8.0 cm from the edge of the test sample. This procedure is based on the NIJ standard 0101.04 for level IIIA protection, but is more severe (bullets impacting at more critical peripheral spots in stead of in the Centre of the sample); a sample showing average trauma of 44 mm or lower and no full penetrations in this test is assumed to pass NIJ IIIA.

In another series of experiments the V₅₀ value was determined for a 9 mm Parabellum full metal jacket bullet (from Dynamit Nobel) analogous to the Stanag 2920 procedure, using Caran d'Ache plastine as backing.

### COMPARATIVE EXPERIMENT A

An assembly was made by stacking 36 plies of 40×40 cm elements cut from Dyneema® UDSB21 laminated fabric (available from DSM Dyneema, The Netherlands). This UD product has an areal density of about 145 μm, and contains 4 cross-plied layers made from Dyneema® SK76 high-performance polyethylene multifilament yarn (of tensile strength 3.5 GPa, modulus 115 GPa; based on ultra-high molar mass polyethylene) and about 18 mass % of an elastomeric matrix material; and a polyethylene separating film on both sides.

The assembly was stabilised by single stitchpaths of about 4 cm length in the 4 corners, and subsequently tested on ballistic performance as indicated above. Results reported in Table 1 are averaged data for at least two independent assemblies, and at least 4 shots for every assembly. The product typically fulfils NIJ threat level IIIA requirements.

### COMPARATIVE EXPERIMENT B

Analogously to experiment A assemblies were made, but the 36 elements were additionally stitched through crosswise, with a stitch length of about 5 mm and distance between parallel stitch paths of about 10 cm. Stitching was done with an Adler® industrial sewing machine, using Serafill® 10 polyester yarn as sewing thread (as for the 4 corner stitches). The flexibility of this assembly was markedly lower than of Comp. Exp. A, as judged by manually bending the assembly in various directions. Ballistic testing showed more variation in trauma results, and 1 of 8 shots fully penetrated the assemblies; see Table 1.

### COMPARATIVE EXPERIMENTS C AND D

Experiment B was repeated, but distance between stitch paths was decreased. Results in Table 1 indicate that the trauma effect tends to increase. Moreover, 1 of 8 shots was not stopped for C; 2 of 8 shots fully penetrated in case of D. Flexibility was judged to be further decreased as compared with the previous experiments.

### EXAMPLE 1

Analogously to experiment A assemblies were made, but the last 12 elements at the rear side of the assembly were stitched through crosswise, with a distance between parallel stitch paths of about 5 cm (defining squares of 5×5 cm). This way of stitching was found to result in only slightly lower flexibility versus the non-stitched reference; both by manual judgment, as well as by measuring bending down under its own weight of 20 cm assembly protruding from a support on which the remaining part was held. The ballistic performance, however, is significantly improved: the trauma effect is markedly lower; and all bullets were stopped (Table 1).

### EXAMPLE 2

Example 1 was repeated, but now the last 12 elements were stitched in two groups of 6 elements, whereby each group was stitched in one direction with distance between parallel paths of 5 cm, and whereby the stitch direction was rotated about 90° for the second group. The stitching did not appear to lower perceived flexibility of the assembly.

### EXAMPLES 3 AND 4

Examples 1 and 2 were repeated, but now the last 8 elements were stitched; resulting in even better trauma performance (all bullets stopped). Flexibility was judged to be on a similar level as the assembly before stitching.

### EXAMPLES 5-10

Examples 1 and 2 were repeated, but now the distance between stitch paths was 4.3; 2.5 or 1 cm The stitching did not appear to significantly lower perceived flexibility of the assemblies; at least no unambiguous relation between stitch path distance and flexibility could be derived from manual evaluation and bending tests. The data in Table 1 confirm the improvement in trauma performance as a result of this partly connecting method.

### COMPARATIVE EXPERIMENTS E

In this series of experiments the effect of applying stitches to the front side of an assembly was assessed, by crosswise stitching all elements of assemblies containing 24 plies of 40×40 cm Dyneema® UD-SB21 (with about 5 cm distance between stitch paths). Parabellum 9 mm bullets were either fired between the stitch paths, or on the stitches. The experiments were performed at least three times. If shot between stitches an average V₅₀ of 508 m/s was found; whereas shooting assemblies right on the stitches resulted in an average V₅₀ of 425 m/s.

These experiments indicate that presence of stitches in the front side elements reduces bullet-stopping power, and further demonstrate the advantage of only interconnecting part of the elements in an assembly in the rear side part.

TABLE 1

| | | | | Ballistic | |
|---|---|---|---|---|---|
| | | | | performance | |
| | Assembly characterisation | | | Average | NIJ |
| | Number | AD | | trauma | level |
| Experiment | of plies | (kg/m²) | Stitching | (mm) | IIIA |
| Comp. Exp. A | 36 | 5.2 | None | 43 | Pass |
| Comp. Exp. B | 36 | 5.2 | 36 elements; crosswise 10 cm | 44 | Fail |
| | | | distance | | |
| Comp. Exp. C | 36 | 5.2 | 36 elements; crosswise 5 cm | 49 | Fail |
| | | | distance | | |
| Comp. Exp. D | 36 | 5.3 | 36 elements; crosswise 2.5 cm | 50 | Fail |
| | | | distance | | |
| Example 1 | 36 | 5.2 | Last 12 elements; crosswise 5 cm | 41 | Pass |
| | | | distance | | |
| Example 2 | 36 | 5.2 | Last 6 + 6 elements; parallel paths | 42 | Pass |
| | | | 5 cm distance; 90° rotated | | |
| Example 3 | 36 | 5.2 | Last 8 elements; crosswise 5 cm | 39 | Pass |
| | | | distance | | |
| Example 4 | 36 | 5.2 | Last 4 + 4 elements; parallel paths | 39 | Pass |
| | | | 5 cm distance; 90° rotated | | |
| Example 5 | 36 | 5.2 | Last 8 elements; crosswise 4.3 cm | 39 | Pass |
| | | | distance | | |
| Example 6 | 36 | 5.2 | Last 4 + 4 elements; parallel paths | 38 | Pass |
| | | | 4.3 cm distance; 90° rotated | | |
| Example 7 | 36 | 5.2 | Last 8 elements; crosswise 2.5 cm | 38 | Pass |
| | | | distance | | |
| Example 8 | 36 | 5.2 | Last 4 + 4 elements; parallel paths | 39 | Pass |
| | | | 2.5 cm distance; 90° rotated | | |
| Example 9 | 36 | 5.2 | Last 8 elements; crosswise 1 cm | 36 | Pass |
| | | | distance | | |
| Example 10 | 36 | 5.2 | Last 4 + 4 elements; parallel paths | 38 | Pass |
| | | | 1 cm distance; 90° rotated | | |

1. Ballistic-resistant assembly comprising a stack of a plurality of flexible elements comprising at least one layer containing a network of high-strength fibres, characterized in that from 5 to 50 mass % of the elements contain connecting means that interconnect adjacent elements at multiple spots distributed over their surface, whereby the interconnected elements are located in the rear side part of the assembly, i.e. the side opposite to the side facing the threat or impacting missile.

2. Assembly according to claim 1, wherein the fibres have a tensile strength of at least about 2 GPa.

3. Assembly according to claim 1, wherein the network of fibres is a woven fabric.

4. Assembly according to claim 1, wherein the element contains at least two layers of unidirectionally oriented fibres with the fibre directions in adjacent layers being rotated to each other.

5. Assembly according to claim 4, wherein the layers of unidirectionally oriented fibres are stabilised with a binder.

6. Assembly according to claim 1, wherein the element further comprises a film layer on one or both outer faces.

7. Assembly according to claim 1, wherein the connecting means cover at most 10% of the surface area of an element.

8. Assembly according to claim 1, wherein the connecting means are stitches.

9. Assembly according to claim 1, wherein the connecting means are placed in adjacent paths having a distance from 0.5 to 15 cm.

10. Assembly according to claim 1, wherein about 10-40 mass % of the elements contain connecting means that interconnect adjacent elements at multiple spots distributed over their surface.

11. Assembly according to claim 1, wherein the interconnected elements are grouped in at least two groups of at least 2 elements.

12. Ballistic-resistant article comprising the assembly according to claim 1.

13. Method for making the assembly according to claim 1, comprising stacking a plurality of flexible elements comprising at least one layer containing a network of high-strength fibres, and interconnecting from 5 to 50 mass % of the elements located in the rear side part of the assembly, by applying connecting means at multiple spots distributed over the surface of said elements.

14. Method according to claim 13, wherein the connecting means are applied by stitching.
